(19) United States
(12) Patent Application Publication
(10) Pub. No.: US 2013/0151625 A1
(43) Pub. Date: Jun. 13, 2013

(54) SYSTEMS AND METHODS FOR TOURNAMENT SELECTION-BASED QUALITY CONTROL

(71) Applicants: Yu An Sun, Webster, NY (US); Danny Greg Little, Redwood City, CA (US)

(72) Inventors: Yu An Sun, Webster, NY (US); Danny Greg Little, Redwood City, CA (US)

(73) Assignee: Xerox Corporation, Norwalk, CT (US)

(21) Appl. No.: 13/324,503

(22) Filed: Dec. 13, 2011

(51) Int. Cl. G06F 15/16

(52) U.S. Cl. 709/205

(57) ABSTRACT

Embodiments relate generally to systems and methods for improving crowdsourcing results via a selection technique. In particular, a processing module or other component can distribute or provide a computation task to a set of people. Each person of the set of people can complete the computation task, and provide the respective results to the processing module or other component. Two of the results can be selected, and an additional set of people can be polled to select one of the two results. The selecting and polling can be repeated until a set of selections is compiled. In embodiments, the processing module can perform a merging algorithm to merge or consolidate the set of selections.

### FIELD OF THE INVENTION

This invention relates generally to quality control and, more particularly, to systems and methods for improving crowdsourcing results via a selection technique.

### BACKGROUND OF THE INVENTION

Crowdsourcing allows for groups of people or communities to perform tasks that are traditionally performed by specific individuals. For example, crowdsourcing can be used in brand-sponsored initiatives or forums, competitions and/or challenges, carrying out a design task, refining or carrying out an algorithm, helping capture and analyze large amounts of data, achieving business goals, and/or other usages and applications.

The Amazon® Mechanical Turk (“MTurk”) technique is a crowdsourcing internet marketplace that enables individuals, or “requesters,” to avail human intelligence tasks (“HITs”) to be performed by a set of individuals, or “workers.” In particular, a worker can select a HIT to perform, and, upon performing a particular HIT, the associated requester can award the worker with a specified reward payment. The worker can be asked to fulfill qualifications before engaging a HIT, and the requestor can institute a test to verify a qualification.

However, there are shortcomings in current crowdsourcing techniques, such as MTurk. In particular, the only quality control procedure is via redundancy. Specifically, multiple people work on the same task, and a final result surfaces from the majority result of the multiple tasks. Therefore, the redundancy technique does not allow a small percentage of better quality work to prevail.

Therefore, it may be desirable to have systems and methods for controlling and improving the quality of crowdsourcing results. In particular, it may be desirable to have platforms and techniques for incorporating a tournament selection for results of human computation tasks and performing post-processing algorithms on the tournament selection results.

### SUMMARY

An embodiment pertains generally to a method of processing data. The method comprises receiving a plurality of results related to a computation task performed by as plurality of people, wherein each person of the plurality of people performs the computation task. Further, the method repeats, for a specified amount of times: selecting at least two results of the set of results, and polling an additional plurality of people with the at least two results, wherein each person of the additional plurality of people selects one of the at least two results. Moreover, the method comprises compiling, by a processor, the one of the at least two results that was selected into a plurality of selections.

Another embodiment pertains generally to a system for processing data. The system comprises a computer readable storage medium containing instructions, and a processor, operably connected to the computer readable storage medium, that executes the instructions to perform operations comprising receiving a plurality of results related to a computation task performed by a plurality of people, wherein each person of the plurality of people performs the computation task. The operations further comprise repeating, for a specified amount of times: selecting at least two results of the set of results, and polling an additional plurality of people with the at least two results, wherein each person of the additional plurality of people selects one of the at least two results. Moreover, the operations further comprise compiling the one of the at least two results that was selected into a plurality of selections.

An additional embodiment pertains generally to a computer readable storage medium comprising instructions configured to perform the method comprising receiving a plurality of results related to a computation task performed by a plurality of people, wherein each person of the plurality of people performs the computation task. Further, the method repeats, for a specified amount of times: selecting at least two results of the set of results, and polling an additional plurality of people with the at least two results, wherein each person of the additional plurality of people selects one of the at least two results. Moreover, the method comprises compiling, by a processor, the one of the at least two results that was selected into a plurality of selections.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1A illustrates an exemplary environment comprising associated components and entities, in accordance with embodiments;

FIG. 1B illustrates an exemplary environment comprising associated components and entities, in accordance with embodiments;

FIG. 2 is a chart comprising exemplary data, in accordance with embodiments;

FIG. 3 illustrates an exemplary flow diagram of processing data in accordance with embodiments; and

FIG. 4 illustrates a hardware diagram in accordance with embodiments.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Embodiments as described herein generally relate to quality control systems and methods. In particular, the systems and methods can implement a tournament selection functionality that allows individuals to vote for or select results of computation tasks previously performed by other individuals. As a result, the systems and methods allow a minority of the good quality task results to prevail over a majority of the good quality task results. More particularly, the current systems and methods improve existing quality control techniques by adding a voting scheme to redundancy processing.

As used herein, the term “computation task” can refer to any type of task, test, questionnaire, survey, project, assignment, undertaking, and/or the like that can be completed or undertaken by any single or group of users, people, individuals, communities, and/or the like. Further, as used herein, the “result” of a computation task can refer to any outcome resulting from a user, person, individual, community, and/or the like performing a computation task. In particular, the result can be any type of written or electronic data gathered or generated in the course of performing the computation task.

According to systems and methods as described herein, each person of a set of people can be provided with the same computation task, wherein each person can perform the computation task. Further, a client machine and/or any type of processing logic can receive or access the results of the computation tasks performed by the set of people, and randomly select two of the results. The selected results can be provided to three (3) additional people, who can be polled or otherwise asked to vote on or select one of the results as the “better” result. The votes can be examined to determine which of the selected results received more votes.

The computation task selection and voting functionalies can be repeated a set amount of times such as, for example, an amount equal to the number of people in the set of people. Further, the task performance, result selection, and vote gathering can also be repeated a set number of times, for example to optimize the results based on the type of computation task. Moreover, an automated merging algorithm can be performed to merge the results into a single result, or otherwise reduce the number of results.

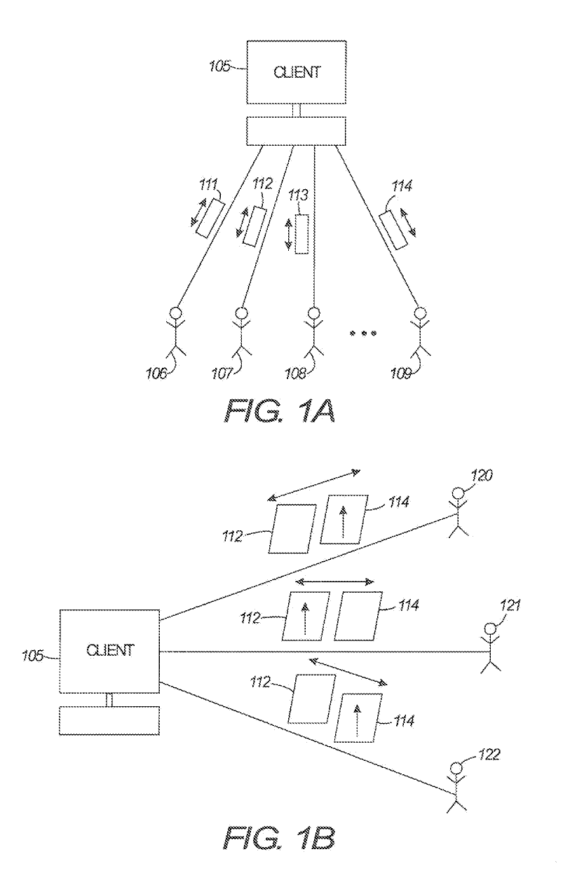

Referring to FIG. 1A, depicted is an exemplary environment 100 in which the exemplary embodiments can be implemented. It should be readily apparent to one of ordinary skill in the art that the environment 100 depicted in FIG. 1A represents a generalized schematic illustration and that other components and/or entities can be added or existing components and/or entities can be removed or modified.

As shown in FIG. 1A, the environment 100 comprises a client 105 and a set of individuals 106, 107, 108, 109 configured to interface or otherwise communicate with the client 105. In embodiments, the client 105 can comprise any type of hardware, software, or a combination thereof. Further, the client 105 can be configured to perform any and all calculations and processing in accordance with the systems and methods as described herein. Still further, the client 105 can comprise any type of communication or interface hardware, software, or a combination thereof, that can be configured to send data to and/or receive data from any entity via any type of wireless or wired data connection.

Each of the set of individuals 106, 107, 108, 109 can represent any user, individual, group of users, or entity that can be configured to respond to any type of task, survey, questionnaire, and/or the like. More particularly, each of the set of individuals 106, 107, 108, 109 can be configured to respectively perform computation tasks 111, 112, 113, 114. In embodiments, multiple instances of the same computation task can be administered or given to the set of individuals 106, 107, 108, 109 by the client 105, or by any other entity, individual, or resource. Further, each of the set of individuals 106, 107, 108, 109 can be configured to concurrently perform the respective computation tasks 111, 112, 113, 114. For example, as shown in FIG. 1A, individual 106 can perform computation task 111, individual 107 can perform computation task 112, and so on. In embodiments, the number of individuals in the set of individuals, and therefore the number of computation tasks, can vary depending on various factors such as, for example, optimization requirements, individual availability, complexity of the computation task, and/or other factors.

Upon completion of the respective computation tasks 111, 112, 113, 114, the set of individuals 106, 107, 108, 109 can be configured to provide respective results of the computation tasks 111, 112, 113, 114 to the client 105, and/or to other entities or resources. For example, the set of individuals 106, 107, 108, 109 can use the client 105 to directly perform the computation tasks, the respective results can be electronically submitted to the client 105, an individual can enter data associated with the respective results into the client 105, and/or the client 105 can receive the respective results via other techniques. Upon receipt of the respective results, the client 105 can be configured to select two of the respective results for further processing. For example, the client 105 can be configured to select results of computation tasks 112 and 114 for further processing. In some embodiments, the client 105 can select more than two results, and the selected results of the computation tasks can be selected specifically, randomly, or according to any other selection technique. Further, the two results of the computation tasks can be selected by an individual, entity, or resource other than the client 105.

Referring to FIG. 1B, the client 105 can be configured to provide the selected results of the computation tasks to an additional set of individuals 120, 121, 122. For example, as shown in FIG. 1B, the client 105 can provide selected results of computation tasks 112 and 114 to each of the additional set of individuals 120, 121, 122. In embodiments, the additional set of individuals 120, 121, 122 can use the client 105 to access the selected results of the computation tasks, the selected results of the computation tasks can be electronically submitted to the additional set of individuals 120, 121, 122 via, for example, the Internet or other networks, and/or the additional set of individuals 120, 121, 122 can receive the selected results of the computation tasks via other techniques. Further, in embodiments, the additional set of individuals 120, 121, 122 can be different from the set of individuals 106, 107, 108, 109, or selected from the set of individuals 106, 107, 108, 109. Still further, the number of individuals in the additional set of individuals can be various amounts such as, for example, three (3), five (5), seven (7), or other amounts.

Once each of the additional set of individuals 120, 121, 122 receives the selected results of the computation tasks 112 and 114, each of the additional set of individuals 120, 121, 122 can be configured to vote on all or part of the selected results of the computation tasks 112, 114. More particularly, each of the additional set of individuals 120, 121, 122 can vote for one of the selected results of the computation tasks 112, 114 as the better result. For example, as signified by the upward arrow in FIG. 1B, the individuals 120 and 122 have selected the result of computation task 114 as the better result, and individual 121 has selected the result of computation task 112 as the better result. In embodiments, the additional set of individuals 120, 121, 122 can vote for the result of the computation task based on any number of factors such as, for example, completeness, appearance, thoroughness, and/or other factors. Further, in embodiments, the additional set of individuals 120, 121, 122 can assign down and up votes to the results, or perform other voting conventions.

In embodiments, selecting the results of the computation tasks and voting on the selected results can be repeated a set amount of times. More particularly, the selection and voting techniques as illustrated in FIG. 1B can be repeated an amount of times equal to the amount of people who completed the computation task, as illustrated in FIG. 1A, or other amounts. For example, if twenty (20) individuals perform a single computation task, then results from two (2) of the computation tasks can be randomly selected and voted upon a total of twenty (20) times. The additional set of individuals selected to vote on the results of the computation tasks can vary for each voting iteration. For example, if three (3) individuals vote on the selected results, then a total of sixty (60) individuals can be selected to vote on the selected results over the course of twenty (20) voting iterations.

Once each of the additional set of individuals 120, 121, 122 has voted on the selected results of computation tasks 112, 114, each of the additional set of individuals 120, 121, 122 can be configured to provide the voting result to the client 105, and/or to other entities or resources. For example, the additional set of individuals 120, 121, 122 can use the client 105 to vote on the selected results of the Computation tasks 112, 114, the voting results can be electronically submitted to the client 105, an individual can enter data from the voting results into the client 105, and/or the client 105 can receive the voting results via other techniques.

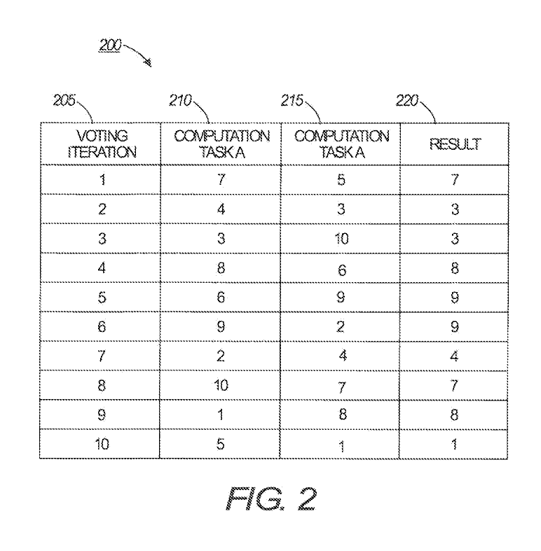

The client 105 can be configured to compile or otherwise organize the voting results received from each of the additional set of individuals 120, 121, 122, over all of the voting iterations. Referring to FIG. 2, depicted is a chart 200 depicting results of voting on computation tasks, compiled over a set number of iterations. It should be appreciated that the data of the chart 200 is merely exemplary, and that other possible data is envisioned.

As shown in FIG. 2, the chart 200 can comprise a voting iteration column 205, as well as a Computation task A column 210, and a computation task B column 215. More particularly, the voting iteration column 205 can identify an iteration of voting on selected computation task results by a set of individuals, such as that depicted in FIG. 1B. Further, the computation task A column 210 and the computation task B column 215 can identify the respective results of computation tasks that are voted on by the set of individuals. For example, as shown in FIG. 2, in voting iteration 1, the set of individuals voted on the results of computation tasks 7 and 5, and in voting iteration 2, the set of individuals voted on the results of computation tasks 4 and 3. As shown in FIG. 2, the number of voting iterations (10) can equal the number of computation tasks (10).

The chart 200 can further comprise a result column 220 that can indicate a result of the voting iteration. For example, in voting iteration 6, the set of individuals voted on the result of computation task 9 being better than the result of computation task 2, and in voting iteration 8, the set of individuals voted on the result of computation task 7 being the better than the result of computation task 10. In analyzing the result column 220, an individual or entity can gauge which of the results of computation tasks are deemed to be “better” relative to other results of computation tasks. For example, the results of computation tasks 3, 7, 8, and 9 were all voted as the better result in two of the voting iterations. It should be appreciated that other conclusions or determinations can be made from the data of the chart 200.

In embodiments, resources of the client 105 and/or other processing logic can repeat the computation task performance depicted in FIG. 1A, the selection of the results of the computation tasks, the result voting depicted in FIG. 1B, and calculations thereof, a set number of times (“stop condition”), to further optimize or refine the results. In particular, the stop condition can be based on the number of individuals, the type of computation task, the amount of available time, and/or other factors.

Once the stop condition is met, resources of the client 105 and/or other processing logic can perform an algorithm or other processing to merge all of the results into a single result, or otherwise a reduced number of results. For example, assume that each individual of a set of individuals is asked to draw rectangles on a blank medical form to mark the individual fields that a user can fill out. The result of this task can be a list of rectangles with x and y coordinates, as well as height data. The post-processing algorithm can compile the result and perform other processing steps. In particular, if more than two (2) rectangles are marked within a 10% tolerance of an actual boundary, then this rectangle can be deemed as a “good” rectangle. Further, for similar x and y coordinates in other computation tasks, then the first rectangle that was agreed upon can be deemed a “good” rectangle in the result. Next, the processing can discard all of the rectangles that were not deemed as “good” rectangles.

Still further, the processing can analyze all the rectangles in the other results with approximately the same x and y coordinates, as measured based on a tolerance. Further, if a rectangle is entirely contained within a larger rectangle, and one or more adjacent rectangles compose 90%, or other amounts, of the area of that larger rectangle, then the processing the discard the larger rectangle. Finally, the processing can return all of the “good” rectangles as a final result. It should be appreciated that this scenario is merely exemplary, and that other optimization processing techniques are envisioned.

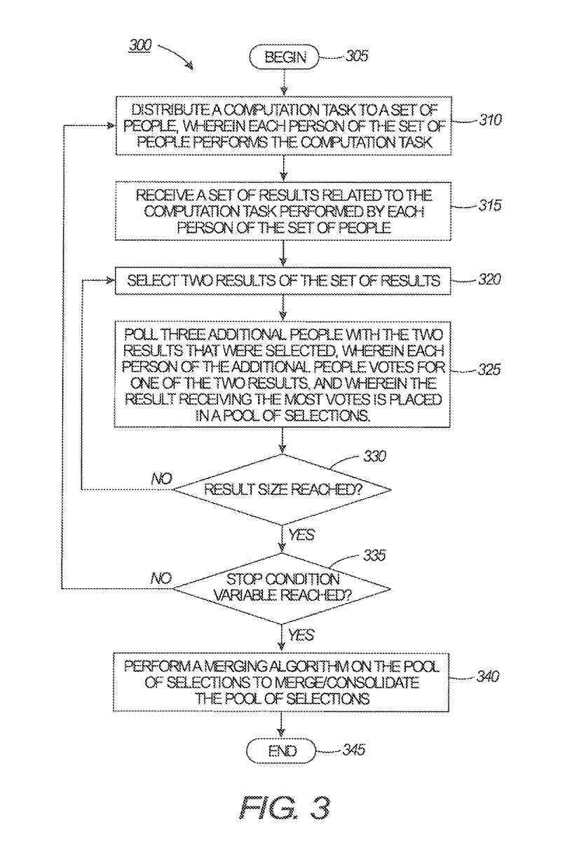

Referring to FIG. 3, depicted is a flowchart detailing a technique 300 for improving human computation task results. The processing of the technique 300 can be performed by any type of processing logic or hardware such as, for example, the resources of the client 105. It should be readily apparent to those of ordinary skill in the art that the flow diagram depicted in FIG. 3 represents a generalized illustration and that other steps can be added or existing steps can be removed or modified.

In 305, processing can begin. In 310, the processing logic can distribute a computation task to a set of people, wherein each person of the set of people performs the computation task. In implementations, the set of people can perform the task concurrently or at different times. In 315, the processing logic can receive a set of results related to the computation task performed by each person of the set of people. For example, the set of results can comprise any type of physical or electronic data gathered or generated in the computation task performance.

In 320, the processing logic can select two results of the set of results. In implementations, the two results can be selected randomly or specifically. In 325, the processing logic can poll three additional people with the two results that were selected, wherein each person of the additional people votes for one of the two results. The result that receives more votes can be placed into a pool of selections. For example, each additional person can vote for which result of the two results that he/she thinks is better, more complete, etc. In 330, the processing logic can determine if the result size has been reached. In implementations, the result size can be equal to the number of people in the set of people. If the result size has not been reached (325, NO), then the processing logic can repeating the selecting and polling functionality.

In contrast, if the result size has been reached (335, YES), then the processing logic can determine if a stop condition variable has been reached. For example, the stop condition variable can be a set number based on the type of computation task, or other factors. If the stop condition variable has not been reached (310, NO), then the processing logic can repeat the computation task distribution functionality, and subsequent processing. In contrast, if the stop condition variable has been reached (340, YES), then the processing logic can perform a merging algorithm on the pool of selections to merge and/or consolidate the pool of selections. For example, the merging algorithm can merge the pool of selections into a single result, or into other set amounts. In 345, the processing can end, repeat, or return to any of the previous steps.

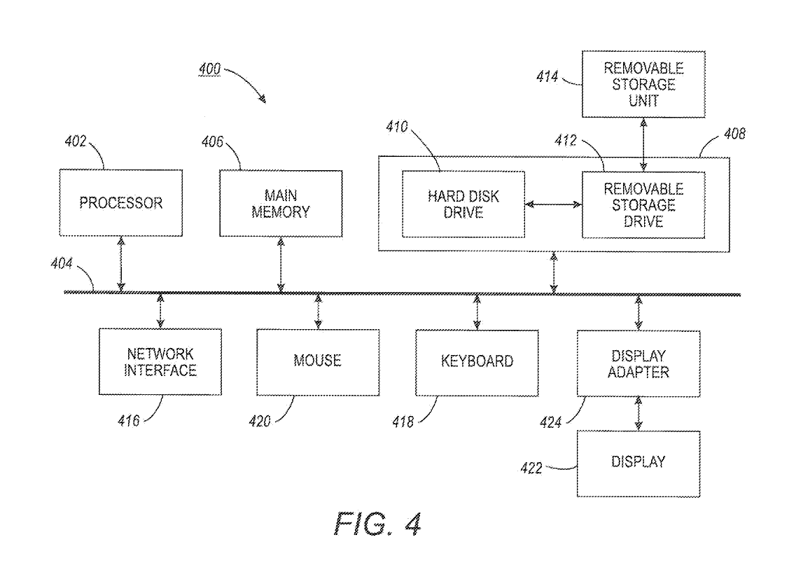

FIG. 4 illustrates an exemplary block diagram of a computing system 400 which can be implemented to store and execute processing modules associated with components of the environment 100, according to various implementations. In embodiments, the processing modules can be stored and executed on the computing system 400 in order to implement the systems, processes, and methods as described herein. The computing system 400 can represent an example of any computing systems in the environment 100 such as, for example, the client 105. While FIG. 4 illustrates various components of the computing system 400, one skilled in the art will realize that existing components can be removed or additional components can be added without departing from the principles of the invention.

As shown in FIG. 4, the computing system 400 can comprise one or more processors, such as a processor 402 that provide an execution platform for embodiments of the processing modules. Commands and data from the processor 402 can be communicated over a communication bus 404. The computing system 400 can also comprise a main memory 406, for example, one or more computer readable storage media such as a Random Access Memory (RAM), where the processing modules and other application programs, such as an operating system (OS) can be executed during runtime, and can comprise a secondary memory 408. The secondary memory 408 can comprise, for example, one or more computer readable storage media or devices such as a hard disk drive 410 and/or a removable storage drive 412, representing a floppy diskette drive, a magnetic tape drive, a compact disk drive, etc., where a copy of an application program embodiment for the processing modules can be stored. The removable storage drive 412 reads from and/or writes to a removable storage unit 414 in a well-known manner. The computing system 400 can also comprise a network interface 416 in order to connect with any type of network, whether wired or wireless.

In embodiments, a user can interface with the computing system 400 and operate the processing modules with a keyboard 418, a mouse 420, and/or a display 422. To provide information from the computing system 400 and data from the processing modules, the computing system 400 can comprise a display adapter 424. The display adapter 424 can interface with the communication bus 404 and the display 422. The display adapter 424 can receive display data from the processor 402 and convert the display data into display commands for the display 422.

Certain embodiments can be performed as a computer program. The computer program can exist in a variety of forms both active and inactive. For example, the computer program can exist as software program(s) comprised of program instructions in source code, object code, executable code or other formats; firmware program(s); or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other Variations are possible within the spirit and scope as defined in the following claims and their equivalents.

What is claimed is:

1. A method of processing data, the method comprising:
receiving a plurality of results related to a computation task performed by a plurality of people, wherein each person of the plurality of people performs the computation task;
repeating, for a specified amount of times:
selecting at least two results of the set of results, and
polling an additional plurality of people with the at least two results, wherein each person of the additional plurality of people selects one of the at least two results; and
compiling, by a processor, the one of the at least two results that was selected into a plurality of selections.

2. The method of claim 1, wherein the additional plurality of people comprises three people.

3. The method of claim 1, wherein the specified amount of times is equal to an amount of people in the plurality of people.

4. The method of claim 1, further comprising:
repeating, for an additional amount of times, the receiving, the selecting, the polling, and the repeating to generate a refined plurality of selections.

5. The method of claim 4, wherein the additional amount of times is based on a type of the computation task.

6. The method of claim 1, further comprising:
performing an algorithm on the plurality of selections to merge the plurality of selections into a single result.

7. The method of claim 1, wherein the computation task is performed and the polling is conducted via a network connection.

8. A system for processing data, the system comprising:
a computer readable storage medium containing instructions; and
a processor, operably connected to the computer readable storage medium, that executes the instructions to perform operations comprising:
receiving a plurality of results related to a computation task performed by a plurality of people, wherein each person of the plurality of people performs the computation task;
repeating, for a specified amount of times:
selecting at least two results of the set of results, and
polling an additional plurality of people with the at least two results, wherein each person of the additional plurality of people selects one of the at least two results; and
compiling the one of the at least two results that was selected into a plurality of selections.

9. The system of claim 8, wherein the additional plurality of people comprises three people.

10. The system of claim 8, wherein the specified amount of times is equal to an amount of people in the plurality of people.

11. The system of claim 8, wherein the processor executes the instructions to perform operations further comprising:
repeating, for an additional amount of times, the receiving, the selecting, the polling, and the repeating to generate a refined plurality of selections.

12. The system of claim 11, wherein the additional amount of times is based on a type of the computation task.

13. The system of claim 8, wherein the processor executes the instructions to perform operations further comprising:
performing an algorithm on the plurality of selections to merge the plurality of selections into a single result.

14. The system of claim 8, wherein the computation task is performed and the polling is conducted via a network connection.

15. A computer readable storage medium comprising instructions configured to perform the method comprising:
receiving a plurality of results related to a computation task performed by a plurality of people, wherein each person of the plurality of people performs the computation task;
repeating, for a specified amount of times:
selecting at least two results of the set of results, and
polling an additional plurality of people with the at least two results, wherein each person of the additional plurality of people selects one of the at least two results; and
compiling the one of the at least two results that was selected into a plurality of selections.

16. The computer readable storage medium of claim 15, wherein the additional plurality of people comprises three people.

17. The computer readable storage medium of claim 15, wherein the specified amount of times is equal to an amount of people in the plurality of people.

18. The computer readable storage medium of claim 15, wherein the method further comprises:
repeating, for an additional amount of times, the receiving, the selecting, the polling, and the repeating to generate a refined plurality of selections.

19. The computer readable storage medium of claim 18, wherein the additional amount of times is based on a type of the computation task.

20. The computer readable storage medium of claim 15, wherein the method further comprises:
performing an algorithm on the plurality of selections to merge the plurality of selections into a single result.
